(19) United States
(12) Patent Application Publication
(10) Pub. No.: US 2026/0155764 A1
(43) Pub. Date: Jun. 4, 2026

(54) ENERGY HARVESTER ACTUATOR

(71) Applicant: Methode Electronics UK Ltd., Lancashire (GB)

(72) Inventor: Assed MIR, Lancashire (GB)

(21) Appl. No.: 18/966,939

(22) Filed: Dec. 3, 2024

(51) Int. Cl. H02N 2/18

(52) U.S. Cl. CPC H02N 2/186

(57) ABSTRACT

A device may include a first activation member including at least one protrusion and configured to slidably move between a first and second axial position, a second activation member including an engagement portion configured to engage the first activation member and to translate a movement between a first and second lateral position of second activation member to a second end thereof to actuate an energy harvester mechanically coupled thereto, and a first spring element arranged between the first activation member and a housing to apply a first spring force to return first activation member to the first axial position. The device may include a second spring element arranged between the second activation member and the housing to apply a second spring force to maintain second activation member in engagement with the first activation member and return the second activation member to the first lateral position.

### FIELD

The present disclosure relates to the field of energy harvesters. More particularly, to energy harvester actuators.

### BACKGROUND

Energy harvesting devices can be used in different devices such as, for example, sensors and switches. Oftentimes, energy harvesting devices can be utilized in devices that are in remote locations where a permanent power supply is not available. In such situations, mechanical energy harvesters can be used instead of batteries that typically require recharging or replacement periodically. The energy produced by the energy harvesting device can be utilized for electronic communication with other components.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a schematic diagram of an example system including a switch device, according to some embodiments.

FIG. 2 is a sectional view of the device of FIG. 1, according to some embodiments.

FIG. 3 is a sectional view of the device of FIG. 1, according to some embodiments.

FIG. 4 is a sectional view of the device of FIG. 1, according to some embodiments.

FIG. 5 is a sectional view of the device of FIG. 1, according to some embodiments.

FIG. 6 is a flow diagram of an example method of manufacturing a switch device, according to some embodiments.

### DETAILED DESCRIPTION

The various embodiments of the present disclosure relate to an energy harvester or a system or device including an energy harvester of the present disclosure. The energy harvester can include an actuator. The device can include an actuator assembly mechanically coupled to the energy harvester, according to some embodiments. The actuator can include mechanical linkages configured to cause multiple actuations of the energy harvester due to an actuation such as, for example, by a user operating a switch device including the energy harvester. The energy harvester can be capable of producing increased energy as a function of the multiple actuations. The energy harvesters can also be capable of storing the electrical energy. The energy harvester can supply the electrical energy to one or more signal components to enable the device including the energy harvester to produce one or more signals, as will be further described herein. Accordingly, the energy harvester is capable of meeting increased energy needs of devices and providing longer functionality based on the actuation. In some embodiments, the movement of the actuator can be linear. In other embodiments, the movement of the actuator can be rotary.

The various embodiments of the energy harvester provide improvements over other known energy harvester switch devices including providing improved efficiency in operation by harvesting a greater amount of energy for a single mechanical actuation compared with other energy harvesters. Other known energy harvesters typically include a rocker or push switch that utilizes the principle of mechanical actuation to cause a single or double energy harvesting cycle by an energy harvester for each actuation of the switch. Accordingly, these other energy harvesters are generally limited in the amount of electrical energy they generate to power respective devices and typically for a limited functionality. Devices including the energy harvester of the present disclosure can be utilized with improved reliability over other energy harvester devices by triggering multiple actuations of the energy harvester and generating more electrical energy that can be harvested for powering the system or device for each actuation of the switch as a function of the operation of the actuator assembly. In other energy harvester devices, the limited amount of energy harvested in these devices can be exhausted in less time such as after a limited number of communication activation attempts. For example, other energy harvester devices can deplete the harvested energy with three activation messages over a 40 msec period.

Moreover, the increased use of Wi-Fi and other radio frequency (RF) devices in an environment of the device including the energy harvester can lead to increased interference or jamming caused by increased traffic from these other devices in the environment. For example, the increased use of Wi-Fi and other RF devices on vehicles, and the resulting increased signal traffic can jam or interfere with the wireless transmission of control signals by the device. The greater electrical power production and storage of the electrical power by the devices including the energy harvester and by operation of the mechanical linkages of the actuator assembly of the present disclosure improves the reliability of transmission links of the device by enabling, for example, longer wireless transmission periods. In this regard, devices including the energy harvester of the present disclosure can be utilized with improved performance and reliability in challenging radio frequency (“RF”) environments where transmissions can easily be jammed by other transmissions in the vicinity of the device. The devices including the energy harvester of the present disclosure are capable of increased energy harvesting for each actuation of the device, thereby enabling the device to maintain an increased transmission duration and improving the probability of a successful message broadcast by the device.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

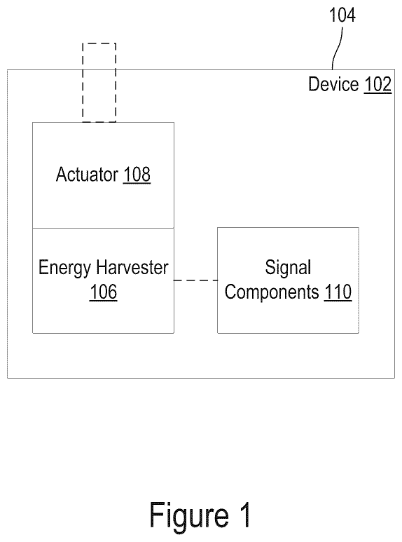

FIG. 1 is a schematic diagram of an example system 100 including a device 102, according to some embodiments.

The system 100 includes a device 102. Device 102 can include a housing 104. Device 102 can include one or more components including, but not limited to, an energy harvester 106 and an actuator 108. Device 102 can be, for example, a switch device configured to actuate energy harvester 106 to generate electrical power in response to actuation of actuator 108. Actuator 108 includes mechanical linkages configured to cause multiple actuations of energy harvester 106 in response to an operation of device 102. That is, device 102 can translate an actuation of actuator 108 into multiple actuations of energy harvester 106 such that energy harvester 106 generates multiple parcels of electrical energy. For example, each of the one or more engagement features on the first body 122 of first activation member 120 can cause an actuation of energy harvester 106 such that energy harvester 106 generates a parcel of energy. In some embodiments, actuator 108 can extend through housing 104 to receive an actuation force to actuate actuator 108. In other embodiments, actuator 108 can be in mechanical connection with another component that is externally located relative housing 104 and the other component can translate the actuation to actuator 108. For example, device 102 can include a button that extends from an aperture of housing 104 and that is mechanically connected to actuator 108, and the button translates an actuation from a user operating the button to actuator 108, and the multiple linkages of the actuator 108 causes multiple actuations of energy harvester 106. In an example, the button can be a rocker button. In another example, the button can be a press button.

System 100 or device 102 can include one or more electrical components. The one or more electrical components can be located in housing 104. The one or more electrical components of device 102 can be configured to generate electrical energy in response to actuation by actuator 108, store the electrical energy, provide one or more signals or control signals in response to actuation of actuator 108, or any combination thereof, among other purposes. The one or more electrical components can include, but is not limited to, electrical conductors, coils, magnets, transducers, resistors, capacitors, inductors, energy storage devices, other electrical components, or any combination thereof. Although not shown in the figures, the one or more electrical components can include a processor and a memory. In some embodiments, the memory can be a non-transitory computer readable media. In some embodiments, device 102 may not be connected to a permanent power supply.

Device 102 can include energy harvester 106. In some embodiments, the one or more electrical components can include energy harvester 106. In some embodiments, the one or more electrical components of device 102 can include energy harvester 106 for generating the electrical energy. In an example, the device 102 can include a printed circuit board including the one or more electrical components in electrical connection with energy harvester 106 for storing the electrical energy generated by energy harvester 106 for operation of device 102.

Device 102 can include one or more signal components 110. In some embodiments, the one or more electrical components can include the one or more signal components 110. The one or more signal components 110 can include, but not limited to, antennas, energy storage devices, other electrical components for producing one or more transmission signals, or any combination thereof. The one or more signal components 110 can utilize the antenna or antennas to transmit the signals generated by the one or more signal components 110 in response to actuation of device 102. The one or more signal components 110 can be configured to utilize the electrical energy produced by energy harvester 106 to produce one or more transmission signals such as, for example, in response to an actuation of device 102. For example, in some embodiments, the one or more signal components 110 can utilize the electrical energy stored at an energy storage device for operation such as, for example, to provide the one or more transmission signals. In this regard, the one or more signal components 110 of device 102 can be powered by the electrical power produced by energy harvester 106 and the one or more signal components 110 may not be powered by a power source external to device 102. In some embodiments, the transmission signals can include control signals for controlling an operation of another device. For example, the transmission signal can be to turn another device on/off.

Device 102 can utilize the one or more signal components 110 to send the one or more transmission signals. The one or more transmission signals can be sent by device 102 using one or more wireless transmission protocols. The wireless transmission protocols can include, but is not limited to, Wi-Fi, Bluetooth, Bluetooth low energy (BLE), ZigBee, Z-wave, low power wide area network (LPWAN), Sigfox, radio frequency identification (RFID), NFC, LoRaWAN, cellular including 3G, 4G, 5G, or LTE, other transmission protocols, or any combination thereof. For example, the one or more signal components 110 can include a 2.5 GHz transmitter operating on Zigbee, Bluetooth, or BLE.

In some embodiments, device 102 can include an energy storage device. The energy storage device can store electrical energy produced by energy harvester 106. The one or more signal components 110 may utilize the electrical energy stored in the energy storage device for operation. One or more electrical components can be utilized to provide device 102 with energy storage device capabilities such as, for example, capacitors or inductors for storing an electrical current produced by energy harvester 106. The electrical power stored in the energy storage device can be utilized by device 102 including the one or more signal components 110 to produce the one or more transmission signals. In some embodiments, the energy storage device can include a battery for storing the electrical energy produced by energy harvester 106.

The system 100 may find use in many contexts. For example, the system 100 may find use in a vehicle, such as passenger-accessible button on a bus, train, boat, airplane, or other vehicle. In this regard, in an example, system 100 can include one or more devices 102 installed on a bus and a passenger on the bus can actuate one of the devices 102 to notify the bus driver that the passenger is requesting a stop, and the device 102 can send a transmission signal that is received by another device configured to provide the notification to the bus driver. For example, system 100 may find use as sensor devices configured to measure one or more parameters and transmit the measurements using the transmission signals. In an example, device 102 can be a light sensor device configured to measure an amount of light in a space or other environment, and the device 102 configured to actuate actuator 108 and energy harvester 106 to power the one or more signal components 110 to send a transmission signal in response to the light measurements exceeding a threshold. In another example, device 102 can be a temperature sensor device configured to measure a temperature of an environment or of a medium, and the device 102 configured to actuate actuator 108 and energy harvester 106 to power the one or more signal components 110 to send a transmission signal in response to the temperature measurements exceeding a threshold. In yet another example, device 102 can be a float sensor device configured to measure a level of a fluid, and the device 102 configured to actuate actuator 108 and energy harvester 106 to power the one or more signal components 110 to send a transmission signal in response to the measurements exceeding a threshold. For example, system 100 can be installed in a fuel tank and device 102 can be a fuel level sensor installed in the fuel tank.

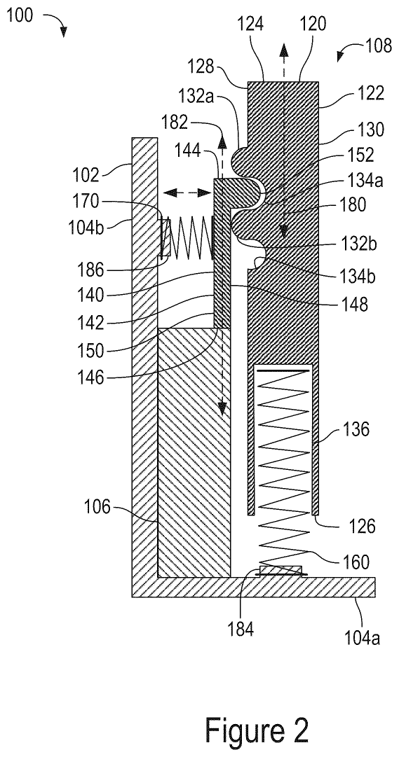

FIG. 2 is a first sectional view of a non-limiting example of the device 102 of FIG. 1, according to some embodiments.

The device 102 can include energy harvester 106 and actuator 108 arranged in housing 104. The actuator 108 can include a first activation member 120, a second activation member 140, and a first spring element 160. The actuator 108 can further include a second spring element 170, according to some embodiments.

First activation member 120 can include a first body 122 arranged on a first axis 180. The first body 122 can include a first end 124, a second end 126 opposite the first end 124, a first side 128, and a second side 130 opposite the first side 128. The first activation member 120 can include one or more engagement members formed on an outer surface of the first activation member 120 at the first side 128 of first body 122.

The first body 122 can be configured to slidably move between a first axial position and a second axial position along the first axis 180 relative housing 104. The first activation member 120 can be positioned in the first axial position by a first spring element 160 applying a spring force onto the first activation member 120 such that a second activation member 140 engages a planar surface of the first side 128 of the first body 122 of first activation member 120 between the engagement members formed on the first side 128 of the first body 122 and the second end 126. The first activation member 120 can be positioned in the second axial position by applying an actuation force onto the first activation member 120 such that the first activation member 120 compresses the first spring element 160 and such that the second activation member 140 engages a planar surface of the first side 128 of the first body 122 of first activation member 120 between the engagement members formed on the first side 128 of first body 122 and the first end 124. In addition, as the first activation member 120 moves between the first axial position and the second axial position, the second activation member 140 engages each of the engagement members formed on the first side 128 of first activation member 120, and this mechanical linkage between the first activation member 120 and the second activation member 140 provides the multiple actuations of the energy harvester 106.

The first body 122 of the first activation member 120 can include at least one protrusion 132 disposed at the first side 128 of the first body 122. The at least one protrusion 132 can be utilized to enable the multiple actuations of energy harvester 106. That is, the sliding movement of the first activation member 120 between the first axial position and the second axial position moves the at least one protrusion 132 located on the first activation member 120 at the first side 128, and the second activation member 140 engaging the first activation member 120 at the first side 128 can engage the at least one protrusion 132, thereby causing the second activation member 140 to pivotably move between the first lateral position and the second lateral position and actuate the energy harvester 106.

The at least one protrusion 132 can include a shape having any of a plurality of profiles and dimensions including, but not limited to, convex shapes, arcuate shapes, angular shapes, orthogonal shapes, other profiles, or any combination thereof, such that the at least one protrusion 132 can protrude (e.g., laterally protrude) from the planar surface of the first side 128 of first body 122 of first activation member 120 and a second activation member 140 engaging (e.g., contacting) the surface of the first side 128 of first body 122 can be displaced in an outward lateral direction relative the first activation member 120 by engaging the at least one protrusion 132 as the first activation member 120 moves between the first axial position and the second axial position along the first axis 180 so as to actuate the energy harvester 106. In some embodiments, the at least one protrusion 132 can have a convex shape such that the at least one protrusion 132 curves outward from the planar surface of the first body 122 of first activation member 120. In other embodiments, the at least one protrusion 132 can have an orthogonal shape such that the at least one protrusion 132 forms a step protruding from the planar surface of the first body 122 of first activation member 120.

According to some embodiments, the at least one protrusion 132 can include two protrusions, three protrusions, four protrusions, or four or more protrusions disposed at the first side 128 of first body 122 of first activation member 120. In some embodiments, the first body 122 of the first activation member 120 can include at least two protrusions such as protrusion 132 located at the first side 128. Each of the protrusions 132 can be spaced apart from each other a certain distance on the first side 128 of the first body 122 of first activation member 120 to enable the multiple actuations of the energy harvester 106, as will be further described herein. As shown in the non-limiting example of device 102 in FIG. 2, the first activation member 120 can include a first protrusion 132a disposed on the first side 128 of first body 122 adjacent the first end 124, and a second protrusion 132b disposed between the first protrusion 132a and the second end 126 of the first body 122 of first activation member 120, in some embodiments.

The first body 122 of the first activation member 120 can include at least one recess 134 disposed at the first side 128 of the first activation member 120 adjacent the at least one protrusion 132 to provide the mechanical linkages for causing multiple actuations of the energy harvester 106. The at least one recess 134 can extend into the first body 122 of first activation member 120 at the first side 128.

The at least one recess 134 can include a shape having any of a plurality of profiles and dimensions including, but not limited to, concave shapes, arcuate shapes, angular shapes, orthogonal shapes, other profiles, or any combination thereof, such that the at least one recess 134 extends into the first body 122 of first activation member 120 at the first side 128 and the engagement portion 152 of second activation member 140 engaging (e.g., contacting) the surface of the first body 122 of first activation member 120 at the first side 128 can be displaced in an inward lateral direction relative the first activation member 120 by engaging the at least one recess 134 as the first activation member 120 moves between the first axial position and the second axial position along the first axis 180 so as to actuate the energy harvester 106. In some embodiments, the at least one recess 134 can have a concave shape that curves inward into the first body 122 of first activation member 120 at the first side 128. In other embodiments, the at least one recess 134 can have an orthogonal shape that forms a step that radially extends inward into the first body 122 of first activation member 120 at the first side 128 and towards a central longitudinal axis of first activation member 120.

According to some embodiments, the at least one recess 134 can include two recesses, three recesses, four recesses, or four or more recesses disposed at the first side 128 of first body 122 of first activation member 120. In some embodiments, the first body 122 of first activation member 120 can include at least two recesses such as recess 134 located at the first side 128, and each of the recesses 134 can be located adjacent the at least one protrusion 132 so as to enable the multiple actuations of the energy harvester 106, as will be further described herein. As shown in the non-limiting example of device 102 in FIG. 2, the first activation member 120 can include a first recess 134a and a second recess 134b, the first recess 134a disposed between first protrusion 132a and second protrusion 132b and the second recess 134b disposed between second protrusion 132b and the second end 126 of first activation member 120, in some embodiments.

According to some embodiments, the first body 122 of first activation member 120 can include a receptacle 136 arranged at the second end 126 of first activation member 120. The receptacle 136 can extend into the first body 122 towards the first end 124 of first activation member 120. In some embodiments, the receptacle 136 can be formed by a bore extending into the first body 122 of first activation member 120, the first body 122 at the second end 126 defining an opening of receptacle 136. The receptacle 136 can be defined by at least one inner sidewall and a bottom surface. The receptacle 136 can include a size and dimensions configured to receive a first spring element 160.

The device 102 includes second activation member 140. Second activation member 140 includes a second body 142 arranged on a second axis 182 (which may be parallel or substantially parallel to first axis 180 when the first and second activation members 120, 140 are at rest). The second body 142 of second activation member 140 includes a first end 144, a second end 146 opposite the first end 144, a first side 148, and a second side 150 opposite the first side 148. The second body 142 of second activation member 140 includes an engagement portion 152 located at the first side 148 of second body 142 of second activation member 140, the engagement portion 152 protruding outward from the second body 142 of second activation member 140 in a radial direction relative second axis 182. In housing 104 of device 102, the second activation member 140 can be arranged adjacent to first activation member 120 such that the engagement portion 152 of second body 142 extends towards the first side 128 of first activation member 120, and the engagement portion 152 can engage a surface of the first side 128 of first body 122 of first activation member 120.

During the movement of the first activation member 120 between the first axial position and the second axial position, the engagement portion 152 engages the surface of the first body 122 of first activation member 120 at the first side 128 including engaging a portion of the surface including one or more engagement members. The engagement portion 152 of the second body 142 of second activation member 140 engaging the one or more engagement members on the surface of the first body 122 of first activation member 120 at the first side 128 causes movement of the second body 142 of second activation member 140 at the first end 144 between a first lateral position and a second lateral position. The one or more engagement members can include at least one protrusion 132, at least one recess 134, or both the at least one protrusion 132 and at least one recess 134, according to some embodiments.

In addition, the second body 142 of second activation member 140 translates the movement at the first end 144 of second body 142 to the second end 146 of second body 142, the second activation member 140 at the second end 146 being mechanically coupled to energy harvester 106. In this regard, the movement of first activation member 120 between the first axial position and the second axial position actuates movement of second activation member 140 between the first lateral position and the second lateral position as a function of the mechanical linkage between first activation member 120 and second activation member 140, and thereby actuates the energy harvester 106 as a function of the mechanical coupling between second activation member 140 and energy harvester 106.

According to some embodiments, the first body 122 of first activation member 120 includes a first longitudinal length and the second body 142 of second activation member 140 includes a second longitudinal length. In some embodiments, the second longitudinal length can be less than the first longitudinal length.

The device 102 includes a first spring element 160. First spring element 160 can be configured to apply a first spring force onto the first activation member 120 to return the first activation member 120 to the first axial position in response to the first activation member 120 being slidably moved to the second axial position from the first axial position by an actuation force applied to the first end 124 of first activation member 120. The first spring element 160 can include, but is not limited to, straight coil springs, barrel springs, concave springs, conical springs, variable rate springs, banana springs, torsion springs, volute springs, flat springs, gas springs, air springs, other types of springs, or any combination thereof.

First spring element 160 can be arranged between first activation member 120 and at least one sidewall of housing 104. First spring element 160 can be configured to apply the first spring force to the first activation member 120 to maintain the first activation member 120 in the first axial position. That is, the first activation member 120 slidably moving from the first axial position to the second axial position in response to an actuation force applied onto the first end 124 of first activation member 120 compresses first spring element 160, and the first spring force of first spring element 160 applied to the first activation member 120 can return the first activation member 120 from the second axial position to the first axial position in response to the actuation force being removed from the first end 124 of first activation member 120, the first activation member 120 slidably moving from the second axial position to the first axial position.

In some embodiments, first spring element 160 can apply the first spring force between the second end 126 of first body 122 of first activation member 120 and the at least one sidewall of housing 104. In other embodiments, the first activation member 120 can include a receptacle 136 at the second end 126 of first body 122, and the first spring element 160 can extend between a bottom surface of receptacle 136 and the at least one sidewall of housing 104 and apply the first spring force of first spring element 160 between the bottom surface of receptacle 136 and the at least one sidewall of housing 104 in response to the actuation force that slidably moved the first activation member 120 from the first axial position to the second axial position being removed from the first end 124 of first body 122 of first activation member 120.

The first spring element 160 returning the first activation member 120 to the first axial position from the second axial position effectively doubles the number of actuations of energy harvester 106 that results from a single actuation of first activation member 120 as a function of the mechanical linkage between the first activation member 120 and the second activation member 140 as a result of the engagement portion 152 engaging a surface of the first activation member 120 at the first side 128 including the one or more engagement members.

In some embodiments, the at least one sidewall of housing 104 can include a first member 184 configured to retain a position of first spring element 160 relative the at least one sidewall of housing 104. In this regard, the first member 184 can be configured to retain the position of first spring element 160 between the at least one sidewall of housing 104 and the first activation member 120. In some embodiments, the first member 184 can be configured to retain the position of first spring element 160 between the at least one sidewall of housing 104 and in the receptacle 136 of first activation member 120.

The first member 184 can include a shape having any of a plurality of profiles and dimensions including, but not limited to, convex shapes, arcuate shapes, angular shapes, orthogonal shapes, other profiles, or any combination thereof, such that the first member 184 retains the position of the first spring element 160 between the at least one sidewall of housing 104 and the first activation member 120. In some embodiments, the first member 184 can have an orthogonal shape so as to form a step protruding from the at least one sidewall of housing 104. In other embodiments, the first member 184 can have an orthogonal shape such that the so as to form a recess extending into the at least one sidewall of housing 104.

The second activation member 140 can be a biasing member, according to some embodiments. The second activation member 140 can be configured to bias between the first lateral position and the second lateral position while maintaining engagement with the surface of the first body 122 of first activation member 120 at the first side 128. The second activation member 140 at the second end 146 can be mechanically coupled to the housing 104 such that the second activation member 140 biasing between the first lateral position and the second lateral position actuates the energy harvester 106 one or more cycles based on the engagement portion 152 of second activation member 140 engaging the at least one protrusion 132 or the at least one recess 134 at the surface of the first body 122 of first activation member 120.

The device 102 can further include second spring element 170, according to some embodiments. Second spring element 170 can be configured to apply a second spring force onto the second activation member 140. The mechanical linkage between first activation member 120 and second activation member 140 can be provided by second spring element 170 applying the second spring force to the second activation member 140 at the second side 150 adjacent the first end 144 of second activation member 140 such that the engagement portion 152 located at the first side 148 of second activation member 140 can maintain engagement with the surface of the first body 122 of first activation member 120 at the first side 128. The second spring element 170 can include, but is not limited to, straight coil springs, barrel springs, concave springs, conical springs, variable rate springs, banana springs, torsion springs, volute springs, flat springs, gas springs, air springs, other types of springs, or any combination thereof.

Second spring element 170 can be arranged between second activation member 140 and at least one sidewall of housing 104. Second spring element 170 can be configured to apply the second spring force to the second activation member 140 at the second side 150 to maintain the second activation member 140 in mechanical linkage with the first activation member 120 and to return the second activation member 140 to the first lateral position from the second lateral position.

In this regard, the engagement portion 152 engaging one or more of the engagement members, or at least one protrusion 132, of the first activation member 120 at the first side 128 can cause the second activation member 140 to pivotably move from the first lateral position to the second lateral position and compress the second spring element 170. In addition, the second spring element 170 can apply the second spring force to the second side 150 of second activation member 140 to maintain the engagement portion 152 in engagement with the surface of first activation member 120 at the first side 128, and to enable the second activation member 140 to return to the first lateral position from the second lateral position when the engagement portion 152 engages one or more of the engagement members, or at least one recess 134, of the first activation member 120 at the first side 128.

In some embodiments, second spring element 170 can apply the second spring force between the second side 150 of second activation member 140 and the at least one sidewall of housing 104 located adjacent the second side 150 of second activation member 140. In other embodiments, the second activation member 140 can include a receptacle (not shown) at the second side 150 of second body 142 of second activation member 140, and the second spring element 170 can extend between a bottom surface of the receptacle of second activation member 140 and the at least one sidewall of housing 104 and apply the second spring force of second spring element 170 between the bottom surface of the receptacle of second activation member 140 and the at least one sidewall of housing 104 to return the second activation member 140 to the first lateral position from the second lateral position when the engagement portion 152 engages a portion of the surface of first activation member 120 at the first side 128 other than the at least one protrusion 132.

The second activation member 140 moving from the first lateral position to the second lateral position actuates the energy harvester 106. In addition, the second spring element 170 returning the second activation member 140 to the first lateral position from the second lateral position actuates the energy harvester 106 so that each of the one or more engagement members formed on the first body 122 of first activation member 120 at the first side 128 triggers an actuation of energy harvester 106, the first activation member 120 and second activation member 140 acting in cooperation to effectively double the number of actuations of energy harvester 106 from a single actuation of first activation member 120 as a function of the mechanical linkage between the first activation member 120 and the second activation member 140.

In some embodiments, the at least one sidewall of housing 104 can include a second member 186 configured to retain a position of second spring element 170 relative the at least one sidewall of housing 104. In this regard, the second member 186 can be configured to retain the position of second spring element 170 between the at least one sidewall of housing 104 and the second activation member 140. In some embodiments, the second member 186 can be configured to retain the position of second spring element 170 between the at least one sidewall of housing 104 and in the receptacle 154 of second activation member 140 at the second side 150. In some embodiments, the housing 104 can include a first sidewall 104a and a second sidewall 104b. The first sidewall 104a can include first member 184 for retaining the position of first spring element 160. The second sidewall 104b can include second member 186 for retaining the position of second spring element 170.

The second member 186 can include a shape having any of a plurality of profiles and dimensions including, but not limited to, convex shapes, arcuate shapes, angular shapes, orthogonal shapes, other profiles, or any combination thereof, such that the second member 186 retains the position of the second spring element 170 between the at least one sidewall of housing 104 and the second activation member 140. In some embodiments, the second member 186 can have an orthogonal shape so as to form a step protruding from the at least one sidewall of housing 104. In other embodiments, the second member 186 can have an orthogonal shape such that the so as to form a recess extending into the at least one sidewall of housing 104.

Although FIG. 1 shows the profile of first activation member 120 as having protrusions 132a, 132b and recesses 134a, 134b, it is to be appreciated that the first activation member 120 can include more or less protrusions or more or less recesses to provide profile of first body 122 at the first side 128 with more or less undulations and can also include a shorter or greater travel length to, for example, allow for producing a greater amount of electrical energy for a mechanical actuation of the first activation member 120.

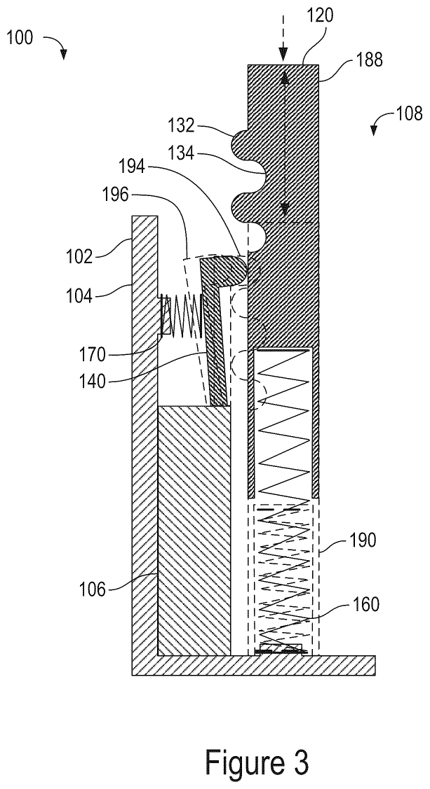

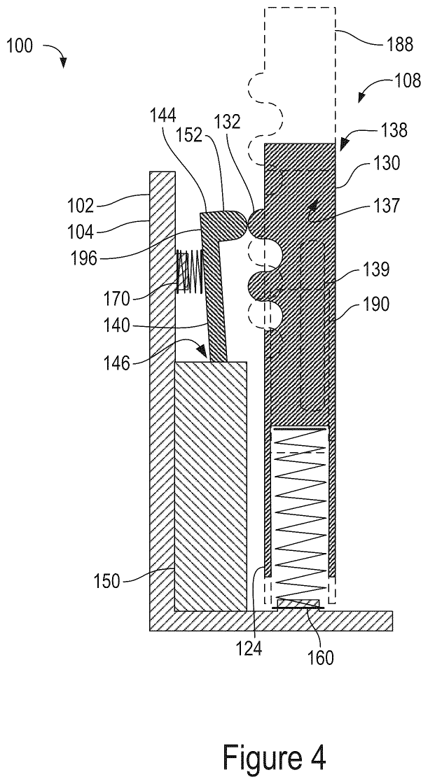

FIG. 3 is a sectional view of the device 102 of FIG. 1 including the first activation member 120 at different positions, according to some embodiments. FIG. 4 is a sectional view of the device 102 of FIG. 1 during an actuation, according to some embodiments. Unless specifically referenced, FIGS. 3 and 4 will be described collectively.

First activation member 120 can include a first body 122 including one or more engagement members. The one or more engagement members can be sequentially arranged in an alternating order on the first body 122 of first activation member 120 at the first side 128. In some embodiments, the one or more engagement members can include at least one protrusion 132 or at least one recess 134. In other embodiments, the one or more engagement members can include at least one protrusion 132 and at least one recess 134. Referring to FIGS. 3 and 4, for example, the first activation member 120 includes one or more engagement members including first protrusion 132a, second protrusion 132b, first recess 134a, and second recess 134b located on first body 122 at the first side 128.

First activation member 120 can slidably move between first axial position 188 and second axial position 190. First activation member 120 can be located at first axial position 188 as a function of first spring element 160 applying the first spring force onto first activation member 120. An actuation force 192 can be applied to the first end 124 of first activation member 120, and the first activation member 120 can slidably move from first axial position 188 to second axial position 190 in response to the actuation force 192. In addition, removing the actuation force from the first activation member 120 can cause the first spring force of first spring element 160 to return the position of first activation member 120 to first axial position 188 by slidably moving the first body 122 from second axial position 190 to first axial position 188.

Second activation member 140 can engage the surface of first body 122 of first activation member 120 at the first side 128. Second activation member 140 can pivotably move laterally outward relative the first side 128 of first activation member 120 from first lateral position 194 to second lateral position 196 by the engagement portion 152 of second activation member 140 engaging the at least one protrusion 132. In addition, second activation member 140 can pivotably move laterally inward relative the first side 128 of first activation member 120 from second lateral position 196 to first lateral position 194 by the engagement portion 152 of second activation member 140 engaging the at least one recess 134.

In this regard, during movement of first body 122 of first activation member 120 between the first axial position 188 and the second axial position 190, the second body 142 of second activation member 140 is configured to translate movement from the first lateral position 194 to the second lateral position 196 at the first end 144 of second body 142 of second activation member 140 to the second end 146 of second body 142 of second activation member 140 to actuate energy harvester 106 a cycle for each of the at least one protrusion 132 in response to the engagement portion 152 engaging the at least one protrusion 132 of first activation member 120. The second body 142 of second activation member 140 is also configured to translate the movement from second lateral position 196 to first lateral position 194 at the first end 144 of the second body 142 of second activation member 140 to the second end 146 of the second body 142 of second activation member 140 to actuate energy harvester 106 a cycle for each of the at least one recess 134 in response to the engagement portion 152 of second activation member 140 engaging the at least one recess 134 at the first side 128 of first body 122 of first activation member 120. Accordingly, the mechanical linkage from the engagement portion 152 of second activation member 140 engaging the first body 122 of first activation member 120 at the first side 128 provides the multiple actuations of energy harvester 106 coupled to the second activation member 140 at the second end 146 in response to an actuation of the first activation member 120.

For example, referring to FIG. 3, the first activation member 120 moving from first axial position 188 to second axial position 190 actuates energy harvester 106 four cycles by the engagement portion 152 of second activation member 140 engaging second recess 134b, engaging second protrusion 132b, engaging first recess 134a, and engaging first protrusion 132a. For example, referring again to FIG. 3, the first activation member 120 moving from second axial position 190 to first axial position 188 actuates energy harvester 106 four cycles by the engagement portion 152 of second activation member 140 engaging first protrusion 132a, engaging first recess 134a, engaging second protrusion 132b, and engaging second recess 134b.

In some embodiments, the housing 104 can include an aperture extending therethrough, and the first end 124 of first activation member 120 can extend through the aperture such that the first body 122 of first activation member 120 extends through the housing 104 and the actuation force can be applied to the first activation member 120 at the first end 124 from a source external to device 102. For example, a user can directly apply the actuation force to the first activation member 120 at the first end 124. In other embodiments, although not shown in the figures, device 102 can include another component in connected engagement with first activation member 120, and application of the actuation force onto the other component can be translated to the first activation member 120 at the first end 124 to cause the first activation member 120 to move between the first axial position 188 and the second axial position 190. The other component can include, for example, a button or button assembly for translating an actuation force onto the first activation member 120. In another example, the other component can include an actuator device for applying an actuation force onto the first activation member 120.

Referring to FIG. 4, the first activation member 120 is shown positioned between first axial position 188 and second axial position 190. Engagement portion 152 of second activation member 140 is shown engaging the at least one protrusion 132 at the surface of first body 122 of first activation member 120 at the first side 128. In addition, the second activation member 140 is shown in the second lateral position 196 and compressing second spring element 170. The second body 142 of second activation member 140 translates the positioning of the first end 144 of second body 142 in the first lateral position 194 to the second end 146 of second body 142 of second activation member 140, the second activation member 140 at the second end 146 being mechanically coupled to the energy harvester 106 to actuate the energy harvester 106 as the first activation member 120 pivotably moves between first lateral position 194 and second lateral position 196.

The first activation member 120 can include a third side 137 extending between first side 128 and second side 130 and a fourth side 138 extending between first side 128 and second side 130 opposite third side 137. In some embodiments, at least one of the third side 137 and fourth side 138 of first activation member 120 can include a slot 139. The slot 139 can be configured to receive a retaining member (not shown) having corresponding dimensions based on the dimensions of slot 139 such that the first activation member 120 can slidably move between the first axial position 188 and the second axial position 190. In some embodiments, the housing 104 can include the retaining member. For example, the retaining member can protrude from the at least one sidewall of housing 104, and the first activation member 120 can be positioned in the housing 104 of device 102 such that the retaining member is arranged in the slot 139 of first activation member 120. In another example, the first activation member 120 at the third side 137 can include a first slot 139a and the first activation member 120 at the fourth side 138 can include a second slot 139b, and the device 102 can include a first retaining member positioned in the first slot 139a and a second retaining member positioned in the second slot 139b to retain the first activation member 120 in the housing 104 while allowing the first activation member 120 to move between the first axial position 188 and the second axial position 190.

In the figures, it is generally shown that the first activation member 120 slidably moves in an axial direction along the first axis relative to the housing 104 of device 102, and the mechanical linkage of second activation member 140 to first activation member 120 translates the movement into the multiple actuations of energy harvester 106. Although not shown in the figures, it is to be appreciated that the first activation member 120 can be a static member (e.g., first activation member 120 does not move relative housing 104) and instead energy harvester 106 may slidably move in an axial direction along a respective axis relative to the housing 104 of device 102. In this regard, second activation member 140 can be mechanically coupled to energy harvester 106 and mechanically linked to first activation member 120 such that the second activation member 140 can be configured to slidingly move with energy harvester 106 between a first axial position and a second axial position while simultaneously engaging (e.g., contacting) the one or more engagement features of first activation member 120 to cause the second activation member 140 at the first end 144 to move between the first lateral position and the second lateral position to cause the multiple actuations of energy harvester 106. For example, device 102 can include a carriage configured to slidingly move between a first position and a second position along a respective axis relative to housing 104 in response to an actuation, and energy harvester 106, second activation member 140, and second spring element 170 can be arranged on the carriage so that the components move therewith in response to an actuation.

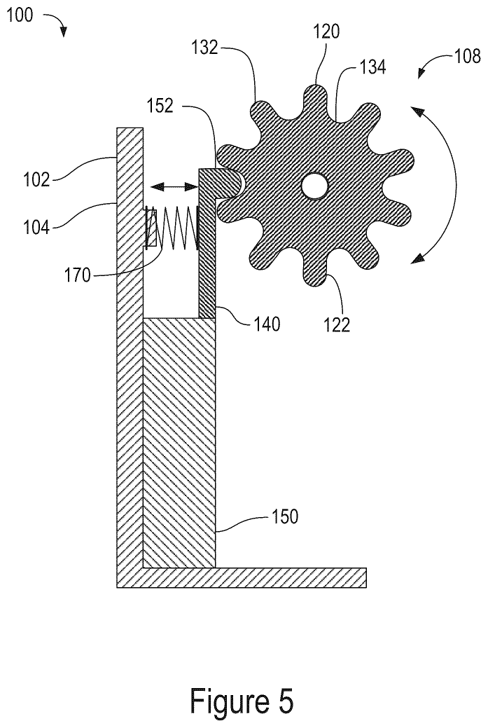

FIG. 5 is a sectional view of device 102 of FIG. 1, according to some embodiments.

Referring to FIG. 5, device 102 can include a first activation member 120 and a second activation member 140. The second activation member 140 can be similar to second activation member 140 as shown in FIGS. 2-4, according to some embodiments. In addition, device 102 can include second spring element 170 located between the at least one sidewall of housing 104 and the second body 142 of second activation member 140 at the second side 150. The second spring element 170 can apply the second spring force onto the second activation member 140 to maintain the engagement portion 152 of second activation member 140 in connected engagement with first activation member 120.

First activation member 120 can include a first body 122 having a circular shaped profile so the first activation member 120 can continuously actuate second activation member 140 with no return motion. For example, the first activation member 120 can be a wheel shaped member. First activation member 120 can include at least one protrusion 132 formed on an outer circumferential surface of the first activation member 120. In some embodiments, the first activation member 120 can include a plurality of protrusions 132. Each of the protrusions 132 can be spaced apart by a certain distance.

In this regard, actuation of first activation member 120 can cause the first body 122 to rotate about a central axis of first activation member 120. The second activation member 140 can include a second body 142 including engagement portion 152 disposed adjacent the first end 144 of second body 142. The engagement portion 152 can engage the outer surface of first activation member 120 including the plurality of protrusions 132. Actuating the first activation member 120 causes the first activation member 120 to rotate about the central axis, and the engagement portion 152 engaging the outer surface of first body 122 of first activation member 120 can cause the second activation member 140 at the first end 144 to move between the first lateral position 194 and the second lateral position 196 in response to the engagement portion 152 of second activation member 140 engaging the outer surface of first activation member 120 including the plurality of protrusions 132 and the outer surface of first activation member 120 between each of the protrusions 132. In other embodiments, the first activation member 120 can be an arcuate shaped member.

The device 102 can include second spring element 170. The second spring element 170 can apply a spring force between the at least one sidewall of housing 104 and the first activation member 120 at the second side 150 to maintain the engagement portion 152 in engagement with the outer surface of first activation member 120 and to return the second activation member 140 to the first lateral position in response to the engagement portion 152 engaging a portion of the outer surface of first activation member 120 between the protrusions or in response to the engagement portion 152 engaging a recess 134 formed at the first body 122 of first activation member 120 between the protrusions 132. In some embodiments, the first body 122 of first end 124 can further include a plurality of recesses 134, each recess 134 disposed between two adjacent protrusions 132.

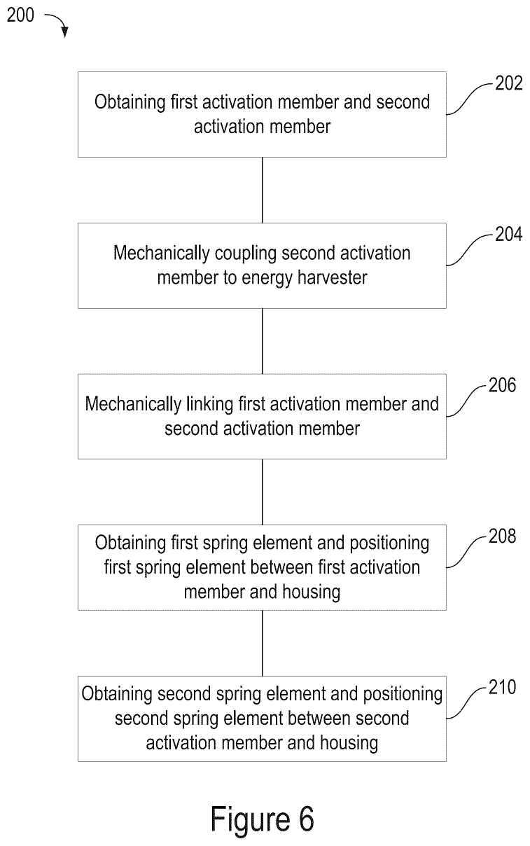

FIG. 6 is a flow diagram of an example method 200 for manufacturing device 102 of FIG. 1, according to some embodiments.

At 202, the method 200 includes obtaining a first activation member 120 and a second activation member 140.

At 204, the method 200 includes mechanically coupling the second activation member 140 to an energy harvester 106.

At 206, the method 200 includes mechanically linking the first activation member 120 and the second activation member 140 in a housing 104 of device 102, the second activation member 140 including the energy harvester 106 mechanically coupled thereto. In some embodiments, arranging the first activation member 120 and the second activation member 140 in the housing 104 can include arranging the first activation member 120 such that a first side 128 of a first body 122 of first activation member 120 is engaging a engagement portion 152 at a first side 148 of second body 142 of second activation member 140. The first activation member 120 can include at least one protrusion 132 at the first body 122 of first activation member 120 at the first side 128. The first activation member 120 can include at least one recess 134 at the first body 122 of first activation member 120 at the first side 128. In some embodiments, the first activation member 120 can include the at least one protrusion 132 and the at least one recess 134 at the first side 128 of the first body 122.

In some embodiments, the first activation member 120 can further include one or more slots 139 configured to receive a corresponding one or more retaining members therein to retain the first activation member 120 in the housing 104 while allowing the first activation member 120 to move between the first axial position and the second axial position in response to the actuation force or the first spring force. In some embodiments, the first activation member 120 can include a first slot 139a at a third side 137 of the first body 122 of first activation member 120. In other embodiments, the first activation member 120 can include a second slot 139b at a fourth side 138 of the first body 122 of first activation member 120. In addition, in some embodiments, the one or more retaining members can be arranged between the first activation member 120 and the at least one sidewall of housing 104. In some embodiments, the one or more retaining members can protrude from a surface of the at least one sidewall of housing 104 and the first activation member 120 can be positioned such that each retaining member is arranged in a corresponding slot 139a, 139b of the first activation member 120. In other embodiments, the at least one sidewall can further include, for example, a receptacle on the at least one sidewall of housing 104, and the one or more retaining members can be positioned in the receptable of housing 104 and the corresponding slot 139a, 139b of the first activation member 120.

At 208, the method 200 includes obtaining a first spring element 160 and positioning the first spring element 160 between a second end 126 of first body 122 of first activation member 120 and at least one sidewall of housing 104. The first spring element 160 being configured to apply a first spring force of first spring element 160 to the second end 126 of first body 122 to return the first activation member 120 to a first axial position from a second axial position in response to removal of an actuation force that causes the first activation member 120 to slidably move from the first axial position to the second axial position.

In some embodiments, the first body 122 of first activation member 120 can include a receptacle 136 located at the second end 126 of the first body 122, and the first spring element 160 can be arranged in the receptacle 136, the first spring element 160 extending between a bottom surface of the receptacle 136 and the at least one sidewall of housing 104 to apply a first spring force of the first spring element 160 to the first activation member 120. In some embodiments, the at least one sidewall of housing 104 can include a first member 184, and the first member 184 can retain a position of the first spring element 160 between the first activation member 120 and the housing 104.

At 210, the method 200 includes obtaining a second spring element 170 and positioning the first spring element 160 between a second side 150 of second body 142 of second activation member 140 and at least one sidewall of housing 104. The second spring element 170 being configured to apply a second spring force to the second body 142 of second activation member 140 to maintain the engagement portion 152 of second activation member 140 in engagement with the first body 122 of first activation member 120 at the first side 128 and to return the second activation member 140 to a first lateral position from a second lateral position in response to the engagement portion 152 engaging the surface of first activation member 120 at the first side 128 transitioning from at least one protrusion 132 to at least one recess 134.

In some embodiments, the second body 142 of first end 144 can include a receptacle located at the second side 150 of the second body 142, and the second spring element 170 can be arranged in the receptacle of the second activation member 140. The second spring element 170 can extend between a bottom surface of the receptacle and the at least one sidewall of housing 104 to apply a second spring force of the second spring element 170 to the second activation member 140. In some embodiments, the at least one sidewall of housing 104 can include a second member 186, and the second member 186 can retain a position of the second spring element 170 between the second activation member 140 and the housing 104.

In some embodiments, the method 200 can further include electrically connecting the energy harvester 106 to one or more electrical components configured to provide one or more control signals in response to an actuation of actuator 108. In other embodiments, the method 200 can further include electrically connecting the energy harvester 106 to one or more signal components 110 configured to provide one or more control signals in response to an actuation of actuator 108.

In some embodiments, a switch configured to actuate an energy harvester to generate electrical power in response to actuation, the switch including a first activation member including a first body arranged on a first axis, the first body configured to slidably move between a first axial position and a second axial position along the first axis, and at least one protrusion disposed at a first side of the first body; a second activation member including a second body arranged on a second axis, the second body configured to translate a movement at a first end of the second body to a second end of the second body, and an engagement portion disposed at a first side of the second body, the engagement portion configured to engage the first side of the first body including the at least one protrusion, wherein the movement of the second body of the second activation member between a first lateral position and a second lateral position actuates the energy harvester mechanically coupled to the second end of the second body; and a first spring element arranged between a second end of the first body and a housing, the first spring element configured to apply a first spring force to return the first activation member to the first axial position.

In some embodiments, the switch further includes a second spring element arranged between a second side of the second activation member and the housing, the second spring element configured to apply a second spring force to maintain the second activation member in engagement with the first activation member and to return the second activation member to the first lateral position.

In some embodiments, at the switch, wherein the first end of the second body moving from the first lateral position to the second lateral position compresses the second spring element and actuates the energy harvester, and wherein the second spring element applying the second spring force to the second body enables the movement of the first end of the second body from the second lateral position to the first lateral position to actuate the energy harvester.

In some embodiments, at the switch, wherein, in response to applying an actuation force to a first end of the first activation member, the first body is configured to slidably move from the first axial position to the second axial position along the first axis and compress the first spring element, and wherein, in response to removing the actuation force from the first end of the first activation member, the first spring element is configured to apply the first spring force to the first body and return the first body from the second axial position to the first axial position.

In some embodiments, at the switch, wherein, during movement of the first body between the first axial position and the second axial position, the second activation member is configured to: in response to the engagement portion engaging the at least one protrusion of the first activation member, translate movement from the first lateral position to the second lateral position at the first end of the second body to the second end of the second body to actuate the energy harvester, and in response to the engagement portion engaging the first side of the first body other than the at least one protrusion, translate movement from the second lateral position to the first lateral position at the first end of the second body to the second end of the second body to actuate the energy harvester.

In some embodiments, at the switch, wherein the first spring element is arranged between a first sidewall of the housing and the first activation member, and wherein the second spring element is arranged between a second sidewall of the housing and the second activation member.

In some embodiments, at the switch, wherein the first activation member longitudinally extends through an aperture of the housing and the first end of the first activation member protrudes from the housing to enable a user to actuate the first activation member.

In some embodiments, at the switch, wherein the first activation member further includes: at least one recess disposed at the first side of the first activation member adjacent the at least one protrusion, wherein, during movement of the first body between the first axial position and the second axial position, the second activation member is configured to: in response to the engagement portion engaging the at least one protrusion of the first activation member, translate movement from the first lateral position to the second lateral position at the first end of the second body to the second end of the second body to actuate the energy harvester, and in response to the engagement portion engaging the at least one recess at the first side of the first body, translate movement from the second lateral position to the first lateral position at the first end of the second body to the second end of the second body to actuate the energy harvester.

In some embodiments, at the switch, wherein the first activation member includes: a first protrusion disposed adjacent the first end, and a second protrusion disposed between the first protrusion and the second end of the first activation member.

In some embodiments, at the switch, wherein the engagement portion engaging the first protrusion actuates the energy harvester a first cycle, and wherein the engagement portion engaging the second protrusion actuates the energy harvester a second cycle.

In some embodiments, at the switch, wherein the first activation member includes: a first recess disposed between the first protrusion and the second protrusion, and a second recess disposed between the second protrusion and the second end of the first activation member.

In some embodiments, at the switch, wherein the engagement portion engaging the first recess actuates the energy harvester a third cycle, and wherein the engagement portion engaging the second recess actuates the energy harvester a fourth cycle.

In some embodiments, an actuator assembly for a switch to trigger an energy harvester to generate electrical power to produce one or more control signals, the actuator assembly including a first activation member including a first body arranged on a first axis, the first body configured to slidably move between a first axial position and a second axial position along the first axis; and at least one protrusion disposed at a first side of the first body; a second activation member including: a second body arranged on a second axis, the second body configured to translate a movement of at a first end of the second body to a second end of the second body to cycle the energy harvester, and an engagement portion disposed at a first side of the second body, the engagement portion configured to engage the first body at the first side including the at least one protrusion, wherein the movement of the second body of the second activation member between a first lateral position and a second lateral position actuates the energy harvester mechanically coupled to the second end of the second body; a first spring element arranged between the first body and a housing, the first spring element configured to apply a first spring force and maintain the first activation member in the first axial position; and a second spring element arranged between a second side of the second activation member and the housing, the second spring element configured to apply a second spring force and maintain the second activation member in the first lateral position.

In some embodiments, at the actuator assembly, wherein, in response to applying an actuation force to a first end of the first activation member, the first body is configured to slidably move from the first axial position to the second axial position along the first axis and compress the first spring element, and wherein, in response to removing the actuation force from the first end of the first activation member, the first spring element is configured to apply the first spring force to the first body and return the first body from the second axial position to the first axial position.

In some embodiments, at the actuator assembly, wherein, during movement of the first body between the first axial position and the second axial position, the second activation member is configured to: in response to the engagement portion engaging the at least one protrusion of the first activation member, translate movement from the first lateral position to the second lateral position at the first end of the second body to the second end of the second body to actuate the energy harvester, and in response to the engagement portion engaging the first side of the first body other than the at least one protrusion, translate movement from the second lateral position to the first lateral position at the first end of the second body to the second end of the second body to actuate the energy harvester; and wherein the first end of the second body moving from the first lateral position to the second lateral position compresses the second spring element, and the second spring element applying the second spring force onto the second body enables the movement of the first end of the second body from the second lateral position to the first lateral position to actuate the energy harvester.

In some embodiments, at the actuator assembly, wherein the first spring element is arranged between a first sidewall of the housing and the first activation member, and wherein the second spring element is arranged between a second sidewall of the housing and the second activation member.

In some embodiments, at the actuator assembly, wherein the first activation member extends through an aperture of the housing and the first end of the first activation member protrudes from the housing to enable a user to actuate the first activation member.

In some embodiments, at the actuator assembly, wherein the first activation member further includes: at least one recess disposed at the first side of the first activation member adjacent the at least one protrusion; wherein, during movement of the first body between the first axial position and the second axial position, the second activation member is configured to: in response to the engagement portion engaging the at least one protrusion of the first activation member, translate movement from the first lateral position to the second lateral position at the first end of the second body to the second end of the second body to actuate the energy harvester, and in response to the engagement portion engaging the at least one recess at the first side of the first body, translate movement from the second lateral position to the first lateral position at the first end of the second body to the second end of the second body to actuate the energy harvester.

In some embodiments, at the actuator assembly, wherein the first activation member includes: a first protrusion disposed adjacent the first end, wherein the engagement portion engaging the first protrusion actuates the energy harvester a first cycle, and a second protrusion disposed between the first protrusion and the second end of the first activation member, wherein the engagement portion engaging the second protrusion actuates the energy harvester a second cycle.

In some embodiments, at the actuator assembly, wherein the first activation member includes: a first recess disposed between the first protrusion and the second protrusion, wherein the engagement portion engaging the first recess actuates the energy harvester a third cycle, and a second recess disposed between the second protrusion and the second end of the first activation member, wherein the engagement portion engaging the second recess actuates the energy harvester a fourth cycle.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, it is to be appreciated that broken lines shown in the figures are exemplary and not intended to be limiting. The figures can include broken lines to denote, for example, an environment, a component, a structure of a component in the environment, among other details.

As used herein, the term “parcel” refers to a quantity or an amount of electrical energy.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be: disposed directly between both of the two other structural elements such that the particular structural component is in direct contact with both of the two other structural elements; disposed directly next to only one of the two other structural elements such that the particular structural component is in direct contact with only one of the two other structural elements; disposed indirectly next to only one of the two other structural elements such that the particular structural component is not in direct contact with only one of the two other structural elements, and there is another element which juxtaposes the particular structural component and the one of the two other structural elements; disposed indirectly between both of the two other structural elements such that the particular structural component is not in direct contact with both of the two other structural elements, and other features can be disposed therebetween; or any combination(s) thereof.

What is claimed is:

1. A switch configured to actuate an energy harvester to generate electrical power in response to actuation, the switch comprising:
a first activation member comprising:
a first body arranged on a first axis, the first body configured to slidably move between a first axial position and a second axial position along the first axis, and
at least one protrusion disposed at a first side of the first body;
a second activation member comprising:
a second body arranged on a second axis, the second body configured to translate a movement at a first end of the second body to a second end of the second body, and
an engagement portion disposed at a first side of the second body, the engagement portion configured to engage the first side of the first body including the at least one protrusion,
wherein the movement of the second body of the second activation member between a first lateral position and a second lateral position actuates the energy harvester mechanically coupled to the second end of the second body; and
a first spring element arranged between a second end of the first body and a housing, the first spring element configured to apply a first spring force to return the first activation member to the first axial position.

2. The switch of claim 1, further comprising:
a second spring element arranged between a second side of the second activation member and the housing, the second spring element configured to apply a second spring force to maintain the second activation member in engagement with the first activation member and to return the second activation member to the first lateral position.

3. The switch of claim 2, wherein the first end of the second body moving from the first lateral position to the second lateral position compresses the second spring element and actuates the energy harvester, and
wherein the second spring element applying the second spring force to the second body enables the movement of the first end of the second body from the second lateral position to the first lateral position to actuate the energy harvester.

4. The switch of claim 2, wherein, in response to applying an actuation force to a first end of the first activation member, the first body is configured to slidably move from the first axial position to the second axial position along the first axis and compress the first spring element, and
wherein, in response to removing the actuation force from the first end of the first activation member, the first spring element is configured to apply the first spring force to the first body and return the first body from the second axial position to the first axial position.

5. The switch of claim 4, wherein, during movement of the first body between the first axial position and the second axial position, the second activation member is configured to:
in response to the engagement portion engaging the at least one protrusion of the first activation member, translate movement from the first lateral position to the second lateral position at the first end of the second body to the second end of the second body to actuate the energy harvester, and
in response to the engagement portion engaging the first side of the first body other than the at least one protrusion, translate movement from the second lateral position to the first lateral position at the first end of the second body to the second end of the second body to actuate the energy harvester.

6. The switch of claim 2, wherein the first spring element is arranged between a first sidewall of the housing and the first activation member, and
wherein the second spring element is arranged between a second sidewall of the housing and the second activation member.

7. The switch of claim 1, wherein the first activation member longitudinally extends through an aperture of the housing and the first end of the first activation member protrudes from the housing to enable a user to actuate the first activation member.

8. The switch of claim 1, wherein the first activation member further comprises:
at least one recess disposed at the first side of the first activation member adjacent the at least one protrusion,
wherein, during movement of the first body between the first axial position and the second axial position, the second activation member is configured to:
in response to the engagement portion engaging the at least one protrusion of the first activation member, translate movement from the first lateral position to the second lateral position at the first end of the second body to the second end of the second body to actuate the energy harvester, and
in response to the engagement portion engaging the at least one recess at the first side of the first body, translate movement from the second lateral position to the first lateral position at the first end of the second body to the second end of the second body to actuate the energy harvester.

9. The switch of claim 8, wherein the first activation member comprises:
a first protrusion disposed adjacent the first end, and
a second protrusion disposed between the first protrusion and the second end of the first activation member.

10. The switch of claim 9, wherein the engagement portion engaging the first protrusion actuates the energy harvester a first cycle, and
wherein the engagement portion engaging the second protrusion actuates the energy harvester a second cycle.

11. The switch of claim 9, wherein the first activation member comprises:
a first recess disposed between the first protrusion and the second protrusion, and
a second recess disposed between the second protrusion and the second end of the first activation member.

12. The switch of claim 11, wherein the engagement portion engaging the first recess actuates the energy harvester a third cycle, and
wherein the engagement portion engaging the second recess actuates the energy harvester a fourth cycle.

13. An actuator assembly for a switch to trigger an energy harvester to generate electrical power to produce one or more control signals, the actuator assembly comprising:
a first activation member comprising:
a first body arranged on a first axis, the first body configured to slidably move between a first axial position and a second axial position along the first axis, and
at least one protrusion disposed at a first side of the first body;
a second activation member comprising:
a second body arranged on a second axis, the second body configured to translate a movement of at a first end of the second body to a second end of the second body to cycle the energy harvester, and
an engagement portion disposed at a first side of the second body, the engagement portion configured to engage the first body at the first side including the at least one protrusion,
wherein the movement of the second body of the second activation member between a first lateral position and a second lateral position actuates the energy harvester mechanically coupled to the second end of the second body;
a first spring element arranged between the first body and a housing, the first spring element configured to apply a first spring force and maintain the first activation member in the first axial position; and
a second spring element arranged between a second side of the second activation member and the housing, the second spring element configured to apply a second spring force and maintain the second activation member in the first lateral position.

14. The actuator assembly of claim 13, wherein, in response to applying an actuation force to a first end of the first activation member, the first body is configured to slidably move from the first axial position to the second axial position along the first axis and compress the first spring element, and
wherein, in response to removing the actuation force from the first end of the first activation member, the first spring element is configured to apply the first spring force to the first body and return the first body from the second axial position to the first axial position.

15. The actuator assembly of claim 14, wherein, during movement of the first body between the first axial position and the second axial position, the second activation member is configured to:
in response to the engagement portion engaging the at least one protrusion of the first activation member, translate movement from the first lateral position to the second lateral position at the first end of the second body to the second end of the second body to actuate the energy harvester, and
in response to the engagement portion engaging the first side of the first body other than the at least one protrusion, translate movement from the second lateral position to the first lateral position at the first end of the second body to the second end of the second body to actuate the energy harvester; and
wherein the first end of the second body moving from the first lateral position to the second lateral position compresses the second spring element, and the second spring element applying the second spring force onto the second body enables the movement of the first end of the second body from the second lateral position to the first lateral position to actuate the energy harvester.

16. The actuator assembly of claim 13, wherein the first spring element is arranged between a first sidewall of the housing and the first activation member, and
wherein the second spring element is arranged between a second sidewall of the housing and the second activation member.

17. The actuator assembly of claim 13, wherein the first activation member extends through an aperture of the housing and the first end of the first activation member protrudes from the housing to enable a user to actuate the first activation member.

18. The actuator assembly of claim 13, wherein the first activation member further comprises:
at least one recess disposed at the first side of the first activation member adjacent the at least one protrusion;
wherein, during movement of the first body between the first axial position and the second axial position, the second activation member is configured to:
in response to the engagement portion engaging the at least one protrusion of the first activation member, translate movement from the first lateral position to the second lateral position at the first end of the second body to the second end of the second body to actuate the energy harvester, and
in response to the engagement portion engaging the at least one recess at the first side of the first body, translate movement from the second lateral position to the first lateral position at the first end of the second body to the second end of the second body to actuate the energy harvester.

19. The actuator assembly of claim 18, wherein the first activation member comprises:
a first protrusion disposed adjacent the first end,
wherein the engagement portion engaging the first protrusion actuates the energy harvester a first cycle, and
a second protrusion disposed between the first protrusion and the second end of the first activation member,
wherein the engagement portion engaging the second protrusion actuates the energy harvester a second cycle.

20. The actuator assembly of claim 19, wherein the first activation member comprises:
a first recess disposed between the first protrusion and the second protrusion,
wherein the engagement portion engaging the first recess actuates the energy harvester a third cycle, and
a second recess disposed between the second protrusion and the second end of the first activation member,
wherein the engagement portion engaging the second recess actuates the energy harvester a fourth cycle.
